(19) United States
(12) Patent Application Publication
(10) Pub. No.: US 2017/0146040 A1
(43) Pub. Date: May 25, 2017

(54) Clamp

(71) Applicant: Ronglong Deng, Changzhou (CN)

(72) Inventor: Ronglong Deng, Changzhou (CN)

(21) Appl. No.: 14/951,783

(22) Filed: Nov. 25, 2015

(51) Int. Cl. F16B 2/12

(52) U.S. Cl. CPC F16B 2/12

(57) ABSTRACT

A clamp has a shell and a spring plate received in the shell. the spring plate has a pair of spring arms. A free end of the each spring arm forms at least one jaw head. The clamp further has a pillar firmly fixed in the shell, a shell cover having a hole defined therein, a shaft linking to the spring plate and extending out from the shell from the hole, a spring between the spring plate and the shell, and, an eccentric wheel pivotally linked to an free end of the shaft extending out from the shell. The clamp is free of self-locking and able to be engage and disengage very quickly and reliably.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The invention relates to a clamp, and more particularly, to the clamp.

2. Description of Related Art

Modular panel frame assembly system is widely used in applications as office partitions, display racks, and window supports. A typical conventional expandable clamp for modular panel frame assembly usually has a shell having a spring plate and an eccentric wheel. The shell is hollow and has a direction flange for the spring plate at a front thereof and the eccentric wheel and a spring plate stage at a rear thereof. An installation hole is defined in the spring plate for cooperation with the eccentric wheel. The spring plate move forward and back in accordance with the eccentric wheel installed in the installation hole. Since a cooperation among the spring plate, the eccentric wheel and the shell, the aforementioned structure of spring plate and eccentric wheel is very complex. At the same time, because of the self-locking angle, the clamp is very liable to self-lock, which highly negatively affect a quick engagement and disengagement of the clamp. And more important, the combination of the spring plate and the eccentric wheel has a drawback of weak in adjustment and strength in connection.

### BRIEF SUMMARY OF THE INVENTION

The main object of the invention is to provide a clamp having an outer eccentric handle which is able to totally avoid self-locking.

Another object of the invention is to provide a clamp having a simpler structure which having a much simpler relationship among the parts thus simplifying a manufacture process of the clamp.

In order to accomplish the above objects, the present invention provides a clamp having a shell and a spring plate received in the shell. the spring plate has a pair of spring arms. The pair of spring arms interlaces in the shell forming a junction and extends out from the shell. A free end of the each spring arm forms at least one jaw head. The clamp further has a pillar firmly fixed in the shell, a shell cover having a hole defined therein, a shaft linking to the spring plate and extending out from the shell from the hole, a spring between the spring plate and the shell, and, an eccentric wheel pivotally linked to an free end of the shaft extending out from the shell. The eccentric handle has a head and a lever, the head having a first edge, a second edge, a third edge and a pivoting hole, the pivoting hole being so arranged that distances between the pivoting hole and the first, the second, and the third edges become larger and larger, the eccentric handle being pivotally linked to a free end of the shaft with a pin passing through the pivoting hole.

Comparing with conventional clamps, the clamp of the invention has an outer eccentric handle instead of an inner eccentric wheel which is highly possible of self-locking. The clamp of the invention is free of self-locking and able to be engage and disengage very quickly and reliably.

These and other objectives, features, and advantages of the present invention will become apparent from the following detailed description, the accompanying drawings, and the appended claims.

### BRIEF DESCRIPTION OF THE SEVERAL VIEWS OF THE DRAWINGS

FIG. 1 is a perspective schematic view of a clamp of the invention.

FIG. 2 is a cross-sectional plane view thereof.

FIG. 3 is another cross-sectional plane view thereof in a released position.

FIG. 4 is yet another cross-sectional plane view thereof in a locked position. And,

FIG. 5 is still yet another cross-sectional plane view thereof showing an eccentric handle thereof.

### DETAILED DESCRIPTION OF THE INVENTION

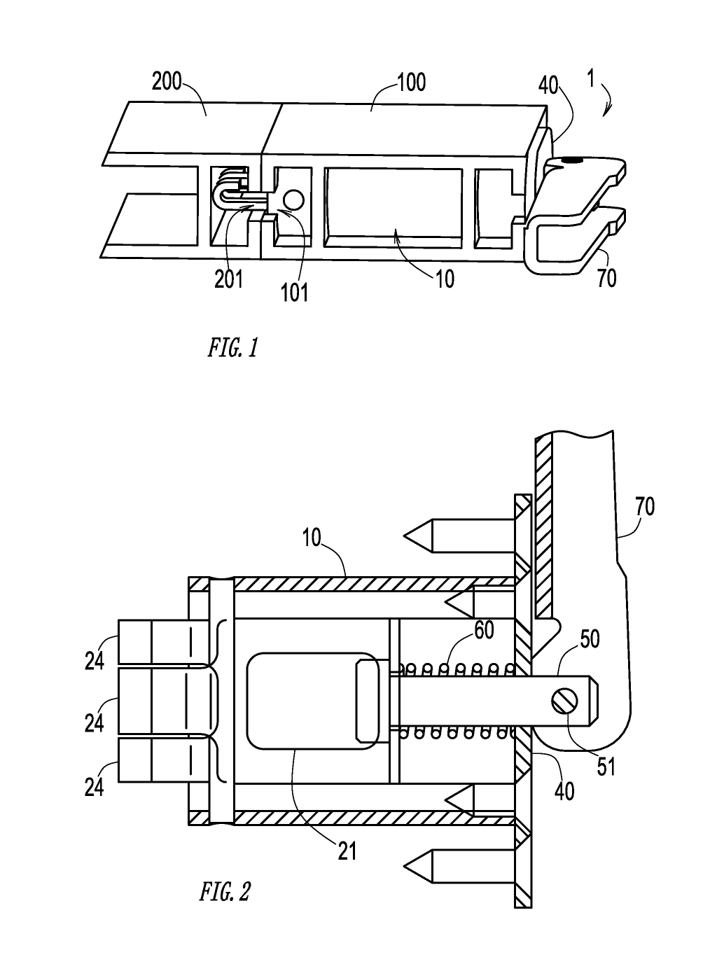

Shown in FIG. 1 is the preferred embodiment of a clamp 1 of the invention linking a first frame member 100 and a second frame member 200. The first frame member 100 has at least one first slit 101 defined therein. The second frame member 200 has at least one second slit 201 forming two opposing flange 202 and 203. The clamp 1 is contained in the first frame member 100 and longitudinally fixed with respect to the second frame member 200.

With reference to FIGS. 2, 3 and 4, the clamp 1 has a shell 10, a spring plate 20 received in the shell 10 and having a pair of spring arms 21, 22, a pillar 30 firmly fixed in the shell 10, a shell cover 40 having a hole 41 defined therein, a shaft 50 linking to the spring plate 20 and extending out from the shell 10 from the hole 41, a spring 60 between the spring plate 20 and the shell 10, and an eccentric wheel 70 pivotally linked to an free end of the shaft 50 extending out from the shell 10. The pair of spring arms 21, 22 interlace in the shell 10 forming a junction 23 and extend out from the shell 10. A free end of the each spring arm 21 or 22 forms at least one jaw head 24. The jaw heads 24 are preferably in a quantity of an odd number and interlacing with each other in order for balance of force between the two spring arms 21, 22. In the embodiment shown in FIG. 2, one spring arm 21 has one jaw head 24 and the other spring arm 22 has two jaw heads 24 and the three, totally. jaw heads 24 are interlacingly arranged.

As particularly shown in FIG. 5, the eccentric handle 70 has ahead 71 and a lever 72. The head 71 has a first edge 73, a second edge 74, a third edge 75 and a pivoting hole 76. The pivoting hole 76 is so arranged that distances between the pivoting hole 76 and the first, the second, and the third edges 73, 74, 75 become larger and larger. The eccentric handle 70 is pivotally linked to the free end of the shaft 50 with a pin 51 passing through the pivoting hole 76.

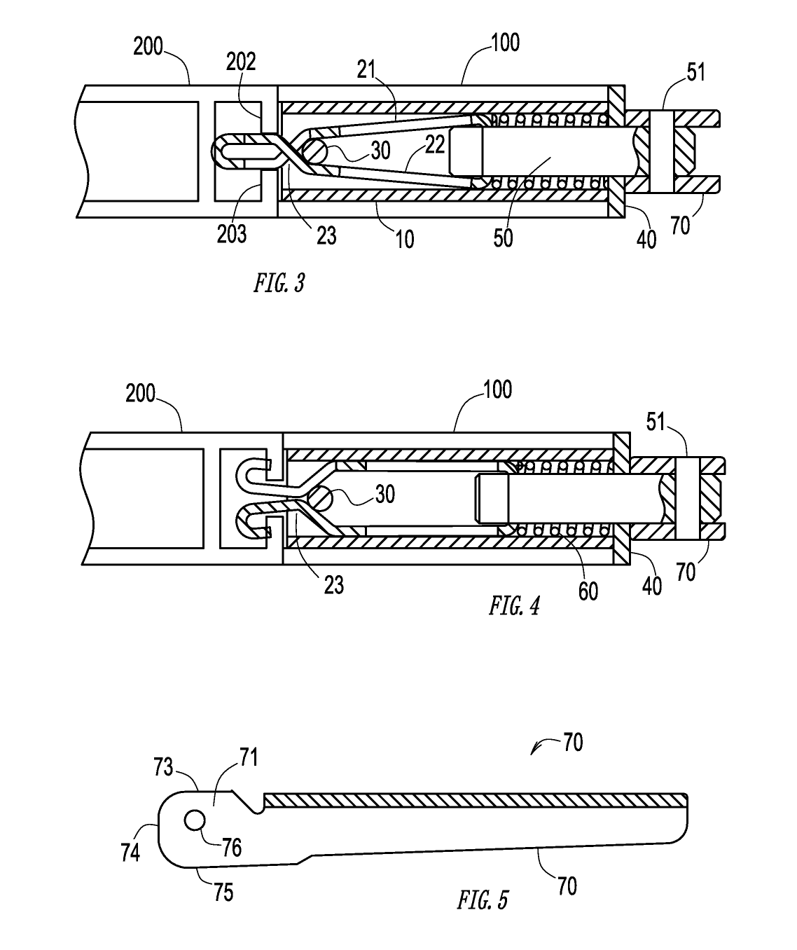

In use, as shown in FIGS. 1 and 3, the clamp 1 is able to be inserted in the first frame member 100 with the jaw, heads 24 sticking out from the first slit 101 thereof. The clamp 1 is able to be longitudinally moved towards the second slit 201 of the second frame member 200, with the interlacing jaw heads 24 being inserted in the second slit 201 in the second frame member 200. Then the user is able to rotate the eccentric handle 70 around the pin 51. As shown in FIG. 4, when the second and the third edges 74, 75 meet the shell cover 40, the spring plate 20 will be pulled back by the shaft 50 against both the pillar 30 and the spring 60. The pillar 30 will meet and push the pair of spring arms 21, 22 and the jaw heads 24 expand. In the position of expanding, the jaw heads 24 engage with the opposing flange 202 and 203 and the clamp 1 will firmly link the first and the second frame member 100 and 200 together. A reverse operation will be able to release the first and the second frame member 100 and 200.

From above description, it is seen that the objects of the present invention have been fully and effectively accomplished. Embodiment of the invention has been shown and described for the purposes of illustrating the functional and structural principles of the present invention and is subject to change without departure from the invention's principles. Therefore, this invention includes all modifications encompassed within the spirit and scope of the following claims.

1. A clamp comprising:
a shell,
a spring plate received in the shell and having a pair of spring arms, the pair of spring arms interlacing in the shell foaming a junction and extending out from the shell, a free end of the each spring arm forms at least one jaw head,
a pillar firmly fixed in the shell,
a shell cover having a hole defined therein,
a shaft linking to the spring plate and extending out from the shell from the hole,
a spring between the spring plate and the shell, and,
an eccentric wheel pivotally linked to an five end of the shaft extending out from the shell, the eccentric handle having a head and a lever, the head having a first edge, a second edge, a third edge and a pivoting hole, the pivoting hole being so arranged that distances between the pivoting hole and the first, the second, and the third edges become larger and larger, the eccentric handle being pivotally linked to a free end of the shaft with a pin passing through the pivoting hole.
